(19) United States
(12) Patent Application Publication
(10) Pub. No.: US 2018/0339852 A1
(43) Pub. Date: Nov. 29, 2018

(54) WASTE STORAGE DEVICE

(71) Applicant: SANGENIC INTERNATIONAL LIMITED, Cramlington, Northumberland (GB)

(72) Inventor: Nicholas CUDWORTH, Cramlington, Northumberland (GB)

(21) Appl. No.: 15/758,193

(22) PCT Filed: Sep. 12, 2016
(86) PCT No.: PCT/GB2016/052815

§ 371 Date: Mar. 7, 2018

(30) Foreign Application Priority Data
Sep. 10, 2015 (GB) 1516048.4
Jul. 27, 2016 (GB) 1612982.7

(51) Int. Cl. B65F 1/06

(52) U.S. Cl. CPC B65F 1/06

(57) ABSTRACT

Disclosed herein is a waste storage device (100) comprising a receiving chamber (132) provided in an upper part of the device (100) and a rotator (136) rotatably mounted in the chamber (132). The rotator (136) comprises an upper annulus (154), and a cylindrical wall (150) extending downwardly from the upper annulus (154). The rotator (136) comprises at least one projection (151) extending therefrom, said at least one projection (151) being arranged to locate with at least one corresponding recess (171) on a waste storage cassette (172) to support the waste storage cassette (172) in the chamber (132) and to ensure rotational engagement between the rotator (136) and the cassette (172).

### BACKGROUND

The problem of how to effectively seal and store nappy waste is well recognised. It is possible to store nappy waste in ordinary household bins; however these are not sufficiently smell proof to enable nappy waste to be hygienically stored except on a very temporary basis. Plastic bags may be used to wrap soiled nappies and other waste in an attempt to block smell leakage, however these bags have limited effect and often comprise more plastic than is needed to wrap a single nappy, therefore creating unnecessary waste.

Several known devices exist which provide means for sealing and storing nappy waste. One known device which is designed for the storage of nappy waste is described in WO2008/059282 (Sangenic International Limited). According to WO2008/059282, a waste container is provided for housing a waste storage cassette. The container includes gripping means to hold a waste package in place whilst the cassette is rotated with respect to the waste package. This forms a twisted seal in the top of the waste package, wherein the twisted seal also acts as the base of a length of tubing for packaging the next waste item to be disposed of. In order to rotate the waste storage cassette, the waste storage device is provided with a waste cassette rotator. The rotator has an inner ledge, from which the waste storage cassette can be suspended, such that, upon rotation of the rotator, the waste storage cassette is also rotated by virtue of friction between the rotator and the cassette.

It is desirable to minimise slippage of the cassette inside the rotator. This can occur, for example, as the tubing is twisted relatively tightly by a user, causing the tubing to exert a force on the cassette which acts against the direction of rotation. Thus, the transfer of rotation from the user to the waste storage cassette can be inefficient. Slippage between the cassette and rotator can also cause the twist formed above a waste item, and the resulting seals formed between each encapsulated waste package, to be relatively loose.

### SUMMARY

An invention is set out in the independent claims. Optional features are set out in the dependent claims.

### FIGURES

Embodiments of the invention will now be described, by way of example, with reference to the drawings, of which:

FIG. 1 is a perspective view of a waste storage device according to an embodiment of the invention;

FIG. 2 is a perspective view of the waste storage device of FIG. 1, including a waste storage cassette;

FIG. 3 is a side view of a lid of a waste storage device, including a plunger, according to an embodiment of the invention;

FIG. 4 is a bottom perspective view of a waste storage device cover according to an embodiment of the invention;

FIG. 5a is a perspective view of a rotator according to an embodiment of the invention;

FIG. 5b is a different perspective view of the rotator of FIG. 5a;

FIG. 6a is a perspective view of a waste storage cassette according to an embodiment of the invention;

FIG. 6b is a different perspective view of the waste storage cassette of FIG. 6a;

FIG. 6c is a perspective view of the waste storage cassette of FIGS. 6a and 6b, shown with a flange attached;

FIG. 7 is a perspective view of the cassette of FIG. 6c suspended from the rotator of FIGS. 5a and 5b;

FIG. 8a is a perspective view of a rotator according to an alternative embodiment;

FIG. 8b is a view from above of the rotator of FIG. 8a;

FIG. 9a is a perspective view of the bottom of a cassette according to an alternative embodiment;

FIG. 9b is a view from above of the waste storage cassette of FIG. 9a; and

FIG. 9c is a cross-sectional view of the waste storage cassette of FIGS. 9a and 9b;

FIG. 10a is a perspective view of a rotator according to another alternative embodiment;

FIG. 10b is a different perspective view of the rotator of FIG. 10a;

FIG. 11a is a perspective view of a cassette according to another alternative embodiment;

FIG. 11b is a different perspective view of the cassette of FIG. 11a;

FIG. 12a is a perspective view of the waste storage cassette of FIGS. 11a and 11b, suspended from the rotator of FIGS. 10a and 10b;

FIG. 13a is a perspective view of a rotator according to another alternative embodiment;

FIG. 13b is a different perspective view of the rotator of FIG. 13a;

FIG. 13c shows a cross-section of the rotator of FIG. 13a taken along the line A-A shown in FIG. 13a.

### OVERVIEW

In overview, a waste storage device is disclosed, including a waste storage cassette receiving chamber, a rotator rotatably mounted in the chamber, and a waste storage cassette.

In one embodiment, the rotator comprises a flange projecting inwardly from a lower portion of a cylindrical wall, wherein the rotator is arranged for suspending the waste storage cassette from the inwardly projecting flange. At least one rib is provided on an inner surface of the rotator, which is arranged to engage with at least one slot on the waste storage cassette, in the manner of a lock and key engagement. This coupling between the rotator and the waste storage cassette virtually eliminates slippage between the waste storage cassette and the rotator.

In another embodiment, the rotator comprises an upper annulus and a cylindrical wall extending downwardly from the inner circumference of the upper annulus. At least one rib is provided on an inner surface of the rotator cylindrical wall, which is arranged to locate with at least one corresponding slot on a waste storage cassette. The waste storage cassette is thus supported in the chamber by the interaction of the rotator rib with the cassette slot, to ensure rotational engagement between the rotator and the cassette.

### DETAILED DESCRIPTION

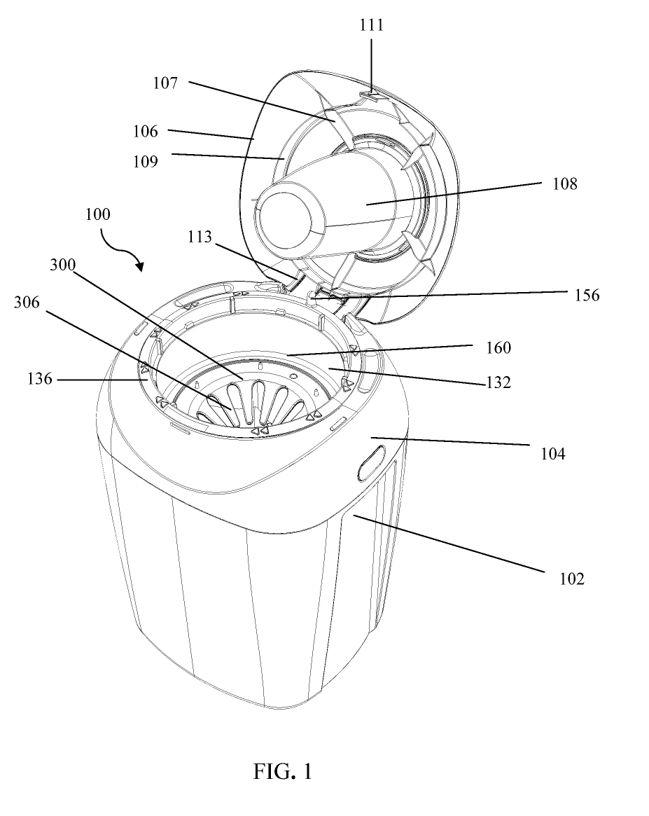

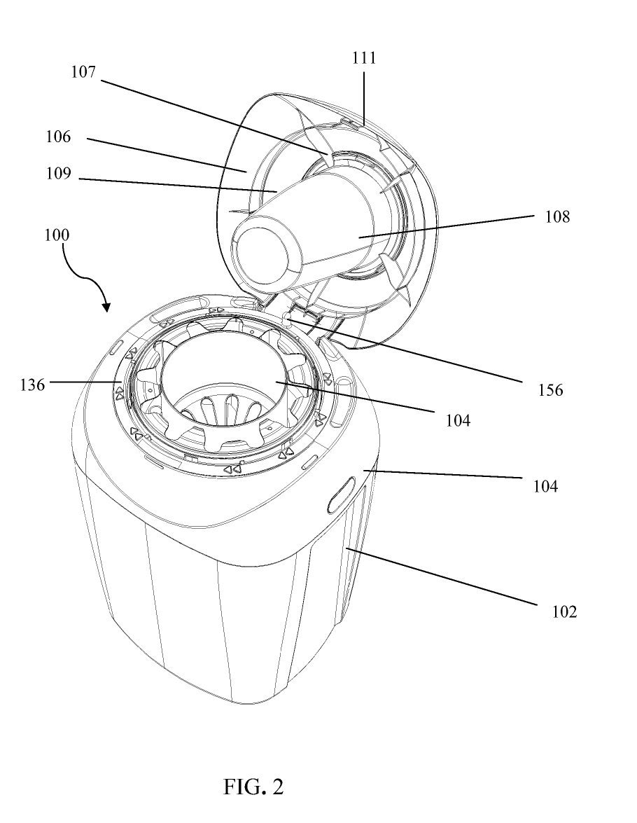

Referring to FIGS. 1 and 2, a waste storage device can be seen. The waste storage device 100 includes a waste storage chamber 102 having a removable cover 104. As described in more detail below, the removable cover 104 includes a waste cassette receiving chamber 132 for receiving a waste storage cassette having flexible tubing for enveloping waste items and further includes a waste storage cassette rotator 136. The rotator provides means for rotating a waste storage cassette with respect to the waste cassette receiving chamber in order to create sealed waste packages in the flexible tubing. The waste cassette rotator 136 further includes a handle 156 which can be actuated by a user in order to rotate the waste cassette rotator 136 about its central axis in the waste cassette receiving chamber 132. The waste storage chamber 102 and removable cover 104 may fit together by any suitable means such as a tab and cooperating recess.

The removable cover 104 includes a lid 106. The lid 106 is preferably hingedly attached to the cover 104 such that it can be actuated in order to provide user access to the inside of the cover 104.

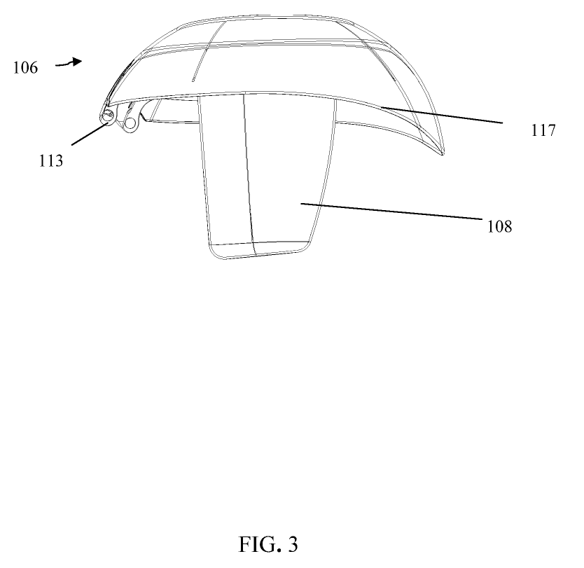

FIG. 1 shows an embodiment of the waste storage device 100 with the lid 106 in an open position. FIG. 2 shows an embodiment of the waste storage device 100 with the lid 106 in an open position, and with a waste storage cassette inserted into the waste storage cassette receiving chamber 132. FIG. 3 shows a side view of the lid removed from the waste storage device.

The cover 104 of the waste storage container comprises a waste cassette receiving chamber 132 configured to receive a waste storage cassette. A plunger 108 extends downwardly from an under surface of the lid 106. The plunger is fixed relative to the lid so that movement of the lid provides movement of the plunger. Preferably the plunger 108 and lid 106 share a common central axis along the extension direction of the plunger 108. The plunger 108 may be hollow, with an open upper end covered by the lid 106 and a closed lower end. According to an embodiment of the invention, the plunger 108 is substantially circular in cross section and tapers radially inwards towards its lower end. This tapering provides clearance for insertion of the plunger 108 into a throat or other waste aperture defined within the removable cover 104 when the lid 106 is closed, as described in more detail below. The plunger 108 may be formed integral to the lid 108 or may attach to the lid 106 by any appropriate inter-engagement means such as a screw fit or snap fit. Optionally, the portion of the lid 106 which covers the upper end of the plunger 108 may be removable.

In order to support the plunger 108 and prevent the lid 106 from deforming under its weight, a plurality of support ribs 107 are provided on the under surface of the lid 106. Preferably the support ribs 107 are spaced apart from one another around the circumference of the upper end of the plunger 108 and each rib 107 extends radially outwards therefrom. Optionally, the lid 106 may include an annular flange 109 extending downwardly from the under surface of the lid 106, wherein the annular flange 109 intersects the support ribs 107 towards their distal ends in order to provide additional support.

A clip 111 is provided at the front of the lid 106, extending from its under surface. The clip 111 inter-engages with a cooperating slot or recess on an outer surface of the removable cover 104, in order to secure the lid 106 in a closed configuration to the cover 104. In an alternative embodiment the lid 106 can lock to the main body of the cover 104 via any appropriate means.

At its back end the lid 106 has a further plurality of ribs on its under surface, preferably extending parallel to one another and outwardly from an outer surface of the annular flange 109. According to an embodiment, the further plurality of ribs includes two hinge ribs 113 which flank two engagement ribs 115. The hinge ribs 113 each include a hole, recess or protrusion towards its distal end, close to the outer edge 117 of the lid 106, for cooperation with a corresponding protrusion, hole or recess on the cover 104, to form a hinged attachment between the lid 106 and cover 104.

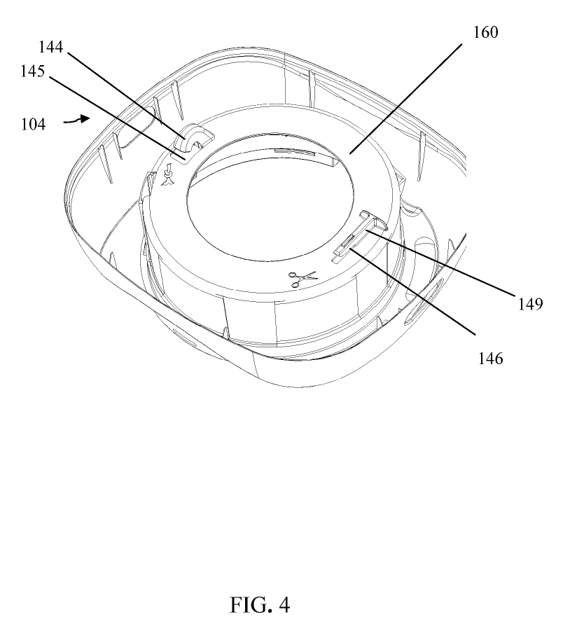

As shown in FIG. 4, the underside of the removable cover 104 includes a hook 144 and cutter 146. The removable cover 104 comprises an annular flange 160. The hook 144 is preferably substantially C-shaped, extending downwardly from an underside of the annular flange 160 and curving upwardly back towards the flange 160, with a small gap 145 defined between the flange 160 and the distal end of the hook 144. When a waste cassette is placed in the waste cassette receiving chamber 132 the user pulls a substantially cylindrical length of tubing from the top of the cassette and ties the tubing into a knot near its upper edge. This knotted tubing forms the base of a waste package into which a nappy or other waste item(s) can be placed. After a waste item has been placed in the tubing, the top of the waste package will be formed by making a twist in the tubing as described below. This twist will then form the base of a subsequent waste package.

Optionally, before a waste item is placed in the waste package the user pushes the knotted base downwards, through an open gripping assembly, and at least partially into the waste passage below. This ensures that sufficient tubing will be available to cover the waste item and to enable the tubing above the waste item to be effectively sealed.

In order to hold a length of tubing containing one or more individually wrapped waste packages in place, and to prevent unravelling of the twist formed above any individual waste package, particularly the first waste package formed within a length of tubing, the knot in the upper edge of the length of tubing is inserted into the hook 144 on the underside of the waste cassette receiving chamber 132. The hook 144 holds the knot in place so that after several uses of a waste storage cassette in the waste storage device 100 a chain of individually wrapped waste packages will extend from the hook 144, down into the waste storage chamber 102 and back up towards the waste storage cassette from which the tubing extends.

As described below, the cutter 146 can be used to cut flexible tubing from a waste storage cassette. The cutter preferably includes a tapered ramp 149 extending from the underside of the flange 160 and a blade or other cutting means provided substantially coplanar with the flange 160 and protected from below by the ramp 149. The tapered portion of the ramp 149 acts as a guide to direct flexible tubing or other material towards the protected cutting means for severance of the material.

In use, when a user wishes to remove the stored waste packages from the waste storage chamber 102 of a waste storage device 100, the tubing which envelops the waste packages must be severed from the unused tubing extending from the cassette. In order to do this, the cover 104 is removed from the waste storage chamber 102. According to a preferred embodiment, the cover 104 can be turned on its side and can rest in a stable position in the mouth of the waste storage chamber 102, to enable the user to more easily cut the flexible tubing without having to hold the cover 104 at the time. The tubing between the top of the cassette and the tubing enveloping the most recently formed waste package is then sliced or otherwise severed using the cutter 146. The user can then unhook the knotted end of the chain of waste packages from the hook 144 and dispose of the waste packages thereafter.

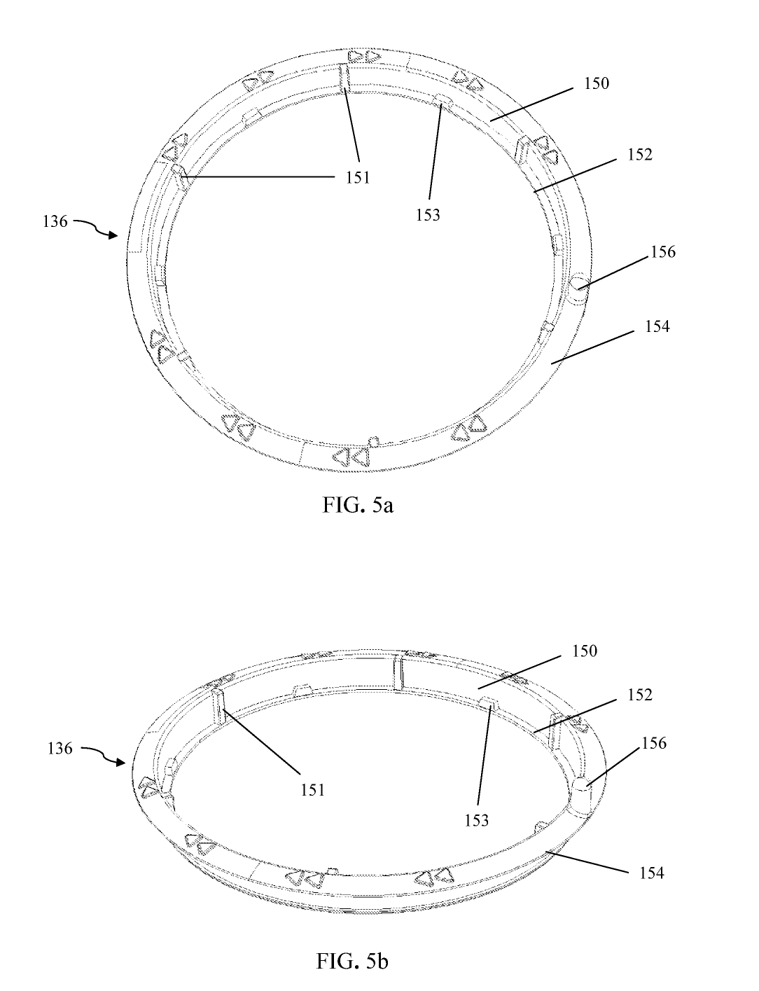

Referring to FIGS. 5a and 5b, a waste cassette rotator 136 can be seen. The waste cassette rotator 136 comprises a cylindrical wall 150 extending substantially concentric with the walls of the cassette receiving chamber, a flange or annular base 152 extending radially inward and substantially perpendicular to the wall 150, and an upper annulus 154 which extends radially outwards from the top of the wall 150 so that it can rest on an upper surface of the cover 104.

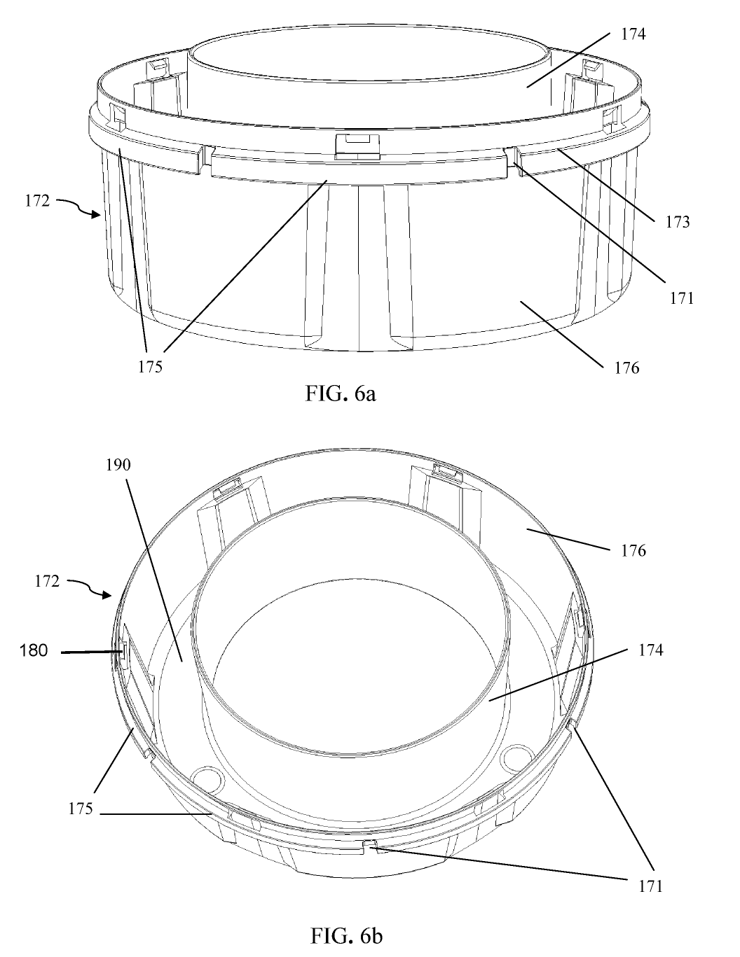

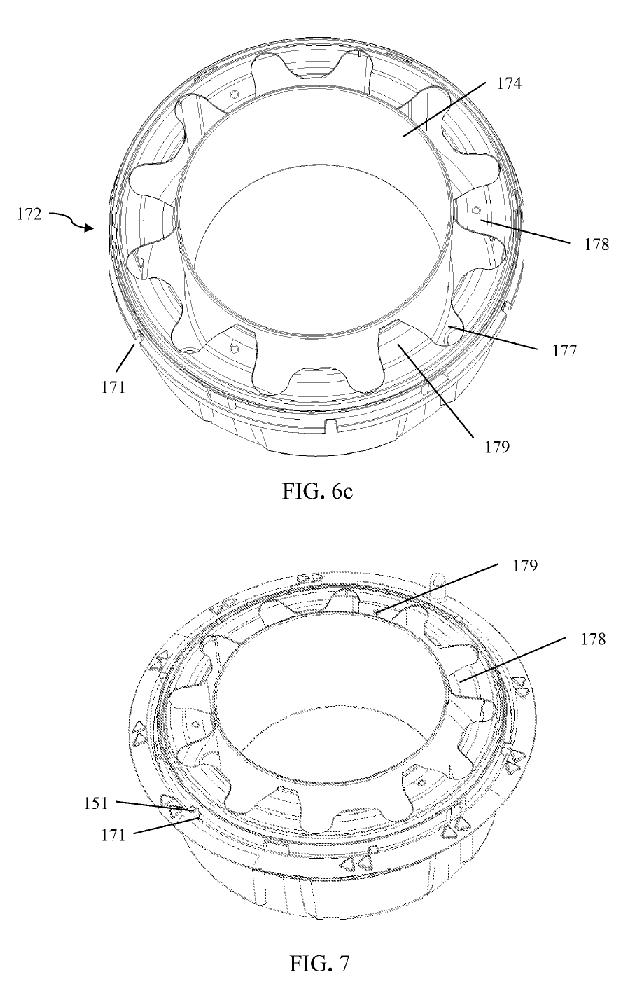

According to a preferred embodiment the waste cassette rotator 136 further includes a handle 156 on its upper annulus 154 which can be actuated by a user in order to rotate the waste cassette rotator 136 about its central axis in the waste cassette receiving chamber 132. The waste cassette rotator 136 is arranged for supporting and housing a waste storage cassette 172 as shown in FIGS. 6a and 6b and for rotating said cassette 172 with respect to the waste cassette receiving chamber 132 as described in more detail below.

The waste cassette rotator 136 further includes a plurality of generally vertically extending ribs 151 which project in a radially inward direction from the inner wall. The ribs 151 project inwardly flush with the flange 152 and in contact with the flange 152, and are thus supported across their base by the flange 152. The ribs 151 may be spaced substantially equidistantly around the inner circumference of the cylindrical wall 150, or may be at varying coplanar separations, or equally angularly spaced but omitting one or more ribs. The ribs 151 extend, in a direction substantially parallel to the central axis of the rotator, between the upper annulus 154 and the flange 152. The ribs are sized, positioned and shaped in an appropriate manner to engage with corresponding slots 171 on a waste storage cassette, as will be described below.

In an alternative embodiment, and with reference to FIGS. 5a to 6c, the rotator also includes a plurality of raised projections 153 interspaced between the ribs 151. The raised projections 153 may be equally interspaced around the circumference of the cylindrical wall 150, or may be positioned in any suitable arrangement around the annular flange 152 of the rotator. The raised projections 153 extend in an upward direction from the flange 152 and in contact with the cylindrical wall 150, and extend at least part of the distance between the flange 150 and the upper annulus 154. The raised projections have a radial dimension substantially equal to that of the flange 152, and extend in a tangential direction around the flange 152.

The raised projections 153 enable the rotate ring 136 to receive different sized cassettes. For example, the radially extending protrusions 175 which comprise the annular formation 173 of the cassette, as will be described in greater detail later, can be arranged to rest on either the raised projections 153 or the annular base 152 of the rotate ring. For a shallower cassette, i.e. a cassette having a smaller cylindrical height, the cassette formation 173 can be designed to rest on the raised projections 153. For a deeper cassette, i.e. a cassette having a larger cylindrical height, the cassette formation 173 can be designed to rest directly on the flange 152. In a cassette according to this embodiment, gaps (not shown) in the formation 173 are provided. These gaps are positioned, sized and shaped appropriately in order to allow the raised projections 153 to pass through the gaps, thereby allowing a bottom surface of the formation 173 to rest directly on the annular flange of the rotate ring. The raised projections thereby allow cassettes of different sizes to fit in the waste storage chamber of the waste storage device, and allow cassettes of different sizes, and/or with differing amounts of film storage space, to be compatible with the same rotate ring.

FIGS. 6a to 6c show a waste storage cassette 172 for use within the waste storage device. The waste storage cassette 172 has a housing which comprises cylindrical inner 174 and outer 176 walls, connected at their lower end by a base 190 to form a substantially U shaped cross section throughout. In the cassette housing between the inner 174 and outer 176 walls of the cassette 172 flexible tubing can be housed. Preferably the flexible tubing is layered or pleated within the cassette housing in order to optimise use of the space therein and provide as much tubing in the cassette 172 as possible. As can be seen in FIG. 6c, extending radially inward from the upper edge of the outer wall 176 is a flange 178. The flange 178 provides at least a partial cover for the cassette housing, preferably exerting downward pressure on the flexible tubing and keeping it as tightly packed in the housing as possible. There is at least one peripheral gap 177 formed between an outer rim of the flange 178 and the inner wall 174, through which a user can access the flexible tubing in order to pull it over the inner wall 174.

Preferably, the inner wall 174 has a rounded profile at its upper edges in order to provide minimal friction, hence enabling smooth flow of flexible tubing thereover.

As is best seen from FIGS. 6c and 7, according to a preferred embodiment the flange 178 comprises a plurality of inward projections or petals 179 extending from the outer wall 176 towards the inner wall 174 of the cassette 172, with a plurality of gaps 177 therebetween which allow flexible tubing to be dispensed from the cassette housing below. The flange 178 can be clipped, snap-fitted or engaged to the outer wall 176 using any suitable means. Preferably the outer edge of the flange 178 is rounded so as to prevent snagging of the tubing when it passes there over.

Preferably, the flange 178 clips or snap fits into the outer wall 176 of the waste storage cassette 172. According to a preferred embodiment, the outer wall 176 includes one or more inwardly extending protrusions 180 on its inner surface with which the flange 178 interengages. Further preferably, the tips of the petals 179, and hence the inner edge of the flange 178, are raised with respect to the outer circumference of the flange.

It will be appreciated from the description below that during use of a waste storage cassette 172 in a waste storage device 100 the petals 179 of the flange 178 improve dosage of the flexible tubing from the cassette housing. In particular, they add tension to the flexible tubing and provide support so that when a relatively heavy waste item is placed in a hollow formed from flexible tubing already dispensed from the cassette 172, the waste item is held in place and its weight does not cause additional tubing to be dispensed from the cassette housing unnecessarily. This is particularly important when there is only a small amount of flexible tubing remaining in the cassette housing, at which time the tubing will not be tightly packed enough to remain trapped in the housing merely due to the covering and downward pressure which the presence of the flange 178 provides.

The petals 179 may each extend to reach the inner wall 174. By extending the petals 179 to reach the inner wall 174 the drag which the flange 178 exerts on the flexible tubing as it is dispensed from the cassette housing is increased. Furthermore, longer petals 179 serve to cover the majority of the flexible tubing in the cassette 172 and prevent it from spilling out before dispensing is required.

According to an alternative embodiment not all of the petals 179 reach the inner wall 174. For example in a cassette 172 having a total of six petals 179 as few as three petals 179, each of a short arc length, should be sufficient to enable adequate user access to the tubing housed therein.

The waste storage cassette 172 further includes a formation 173. The formation takes the form of an annular ledge or flange, which projects radially outwards from an outer surface of the cassette outer wall 176. The formation/ledge 173 is preferably located towards the upper edge of the outer wall 176, but below the flange 178 which extends radially inwards from an inner surface of the outer wall 176.

The formation 173 comprises a number of protrusions 175. The protrusions 175 extend radially outward from an outer surface of the cassette outer wall 176, and are separated by a corresponding number of gaps or slots 171. The slots 171 may be spaced substantially equidistantly around the inner circumference of the cylindrical wall 150, or may be at varying coplanar separations, or equally angularly spaced but omitting one or more slots around the outer circumference of the formation 173, and are positioned, sized and shaped appropriately in order to engage with the ribs 151 of the rotator 136.

FIG. 7 shows a cassette 172 coupled with a rotator 136. In coupling the cassette 172 with the rotator 136, the slots 171 have accepted the ribs 151, and the rotator and cassette are ready for synchronous rotation.

Also provided in the waste storage device shown FIGS. 1 and 2 is a gripping assembly or gripper 300. The gripping assembly comprises a gripping diaphragm. The gripping diaphragm comprises a main body having a central aperture. The central aperture can be circular or of any other appropriate profile. The gripper has a plurality of projecting fingers 306 projecting into the aperture, effectively forming a continuous engagement face but providing additional flexibility. The projecting fingers are arranged to contact an enveloped waste package when the waste storage device 100 is in use. As a result the gripper provides a clear engagement feel when a package is inserted and held in place so that the user can detect by tactile feedback that the arrangement is ready to twist the tubing above the gripped package. Yet further the effectively continuous engagement face provided by the aperture periphery such as the fingers 306 ensures that the tubing is gripped consistently around its circumference.

The gripping assembly connects to the flange 160 of the removable cover 104, thus forming the base of the waste cassette receiving chamber 132. The gripper 300 is preferably removably secured by inter-engagement means to an upper face of the flange 160. The plurality of projecting fingers extend downwardly and inwardly into the ‘throat’ of the waste storage chamber 102.

Referring to FIG. 2, a waste storage cassette 172 is seen in situ in the waste cassette receiving chamber 132 of a waste storage device 100. The cassette 172 is placed in the waste cassette receiving chamber 132, preferably wherein the cassette 172 hangs via the ledge 173 on its outer surface from the rim or annular base 152 of the waste cassette rotator 136. Before placing the cassette 172 in the chamber 132, the user also rotationally orientates the cassette 172 in order to locate the ribs 151 of the rotator 136 into the slots 171 of the cassette 172.

Alternatively, the cassette 172 can be supported at its base by the rim or annular base 152 of the waste cassette rotator 136.

In order to begin using a cassette 172 in the waste storage device 100, the user accesses flexible tubing housed within the cassette 172, pulls a length of tubing therefrom and ties a knot in the end of the tubing as described above. The user then inserts the knot into a hook 144 on the under surface of the cover 104 of the device 100 as described above. As a result, a sealed hollow of tubing is formed in the throat of the waste storage device 100, radially inward of the inner wall 174 of the cassette 172. At this point the waste storage device 100 and cassette 172 are ready for insertion of a waste item into the hollow of tubing.

Once a user has placed a waste item in the hollow of tubing, he or she then actuates the handle 156 on the waste cassette rotator 136.

Rotation of the waste cassette rotator 136 causes rotation of the cassette 172 located thereon. The ribs 151 of the rotator 136 and slots 171 of the cassette 172 act as cooperating inter-engagement means in a similar manner to a lug and recess arrangement, to ensure that the waste storage cassette 172 rotates synchronously with the waste cassette rotator 136.

The rotator 136 and waste storage cassette 136 rotate relative to the waste storage device 100. The contact force exerted by the stationary gripper 300 causes the waste item to remain stationary during rotation of the cassette 172. Rotation of the cassette 172 thereby causes the tubing to twist above the waste item, forming a seal.

According to a preferred embodiment, the waste cassette and waste storage device 100 are arranged so that one single rotation of the waste cassette 172 from its starting position by the waste cassette rotator 136 is sufficient both to grip the tubing above the waste item and form a twist in the tubing in order to complete a sealed waste package.

Once a sealed waste package has been formed as described above, the user can replace the lid 106 of the waste storage device 100 until he or she next wishes to use the device 100. The action of closing the lid 106 causes the plunger 108 to plunge through the aperture in the throat area defined by the gripping assembly, pushing the previously-formed waste package(s) through the throat and down towards the waste storage chamber 102 below. At the same time, this causes additional flexible tubing to be dispensed from the waste cassette 172 in a metered manner. As a result, the plunger 108 creates a hollow of flexible tubing above the previously-formed waste packages(s), wherein the base of the hollow is formed by the twisted tubing above the previously-sealed waste item. When the user next opens the lid 106 of the waste storage device 100, a waste item can be placed directly in the hollow which the plunger 108 has created. Therefore the user does not have to take any additional steps to prepare the cassette 172 for storage of subsequent waste items, once the lid 106 has been re-opened, nor does the user need to push the previously-formed package(s) down into the waste storage chamber 102 manually.

The plunger 108 is arranged to present a fresh area of tubing which is just big enough to receive a waste item comprising a waste nappy and allow a twist seal to be formed above the nappy, without using any additional flexible tubing unnecessarily. This ensures that the maximum possible number of waste packages can be formed from the flexible tubing stored within a single waste cassette 172, making the cassette more cost-effective and environmentally friendly.

A waste storage cassette 172 can be employed in the waste storage device 100 to form a plurality of consecutive waste packages which are stored in the waste storage chamber 102 connected below the cover 104. In order to empty the waste packages from the waste storage chamber 102, the inter-engagement means between the cover 104 and waste storage chamber 102 are released and the cover 104 is lifted from above the waste storage chamber 102. If a cassette 172 in the cover 104 still houses some flexible tubing, the unused flexible tubing extending from the cassette 172 will be continuous with the flexible tubing from which the waste packages have been formed. As described above, in order to release the unused flexible tubing from connection with the previously formed waste packages, the user rips the flexible tubing above the most recently formed waste packaging using the hook 144 and cutter 146 means provided on the underside of the cover 104. Preferably, the components in the cover are made from lightweight materials, so that the user can easily lift the cover and, if desired, hold it in one hand while using the other hand to hold and cut the tubing above the waste packages.

The various components of the waste storage device 100 are preferably formed from lightweight plastic or any other suitable material and can be moulded or otherwise formed in any appropriate manner. Preferably the surfaces of the device are wipe-clean. Preferably the gripping bands in the gripping assembly are formed from elastic or any other suitable material which exhibits the appropriate deformation characteristics.

The embodiments of the waste storage device described provide a hygienic, easy-to-use and cost-effective means for disposing of used nappies and other waste items.

The plunger provides means for preparing the waste storage device and cassette for repeated use by creating hollows of flexible tubing for waste items to be placed into. This saves time and effort for the user and also ensures that the user does not use additional flexible tubing unnecessarily.

By providing an inter-engagement means consisting of ribs on the rotate ring and slots on the cassette, slippage between the cassette and rotator can be virtually eliminated. Slippage can cause the twist formed above the waste item to be loose, which in turn can provide an inadequate seal. Reducing slippage between the rotator and the cassette means that the twists formed above each waste item respectively are consistently tight, improving the seal formed between consecutive enclosed waste packages.

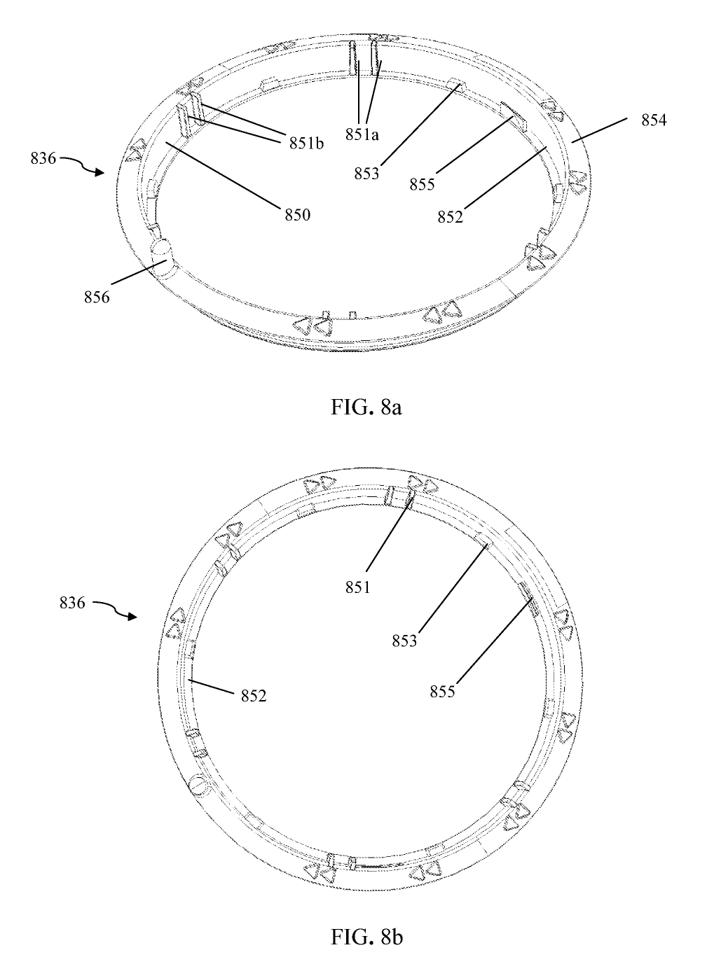

An alternative rotator embodiment is shown in FIGS. 8a and 8b. According to this alternative embodiment, the rotator 836 is similar in structure and operation to the rotator described above. The waste cassette rotator 836 comprises a cylindrical wall 850 extending substantially concentric with the walls of the cassette receiving chamber, a flange or annular base 852 extending substantially perpendicular to the wall 850, and an upper annulus 854 which extends radially outwards from the top of the wall 150 so that it rests on an upper surface of the cover 104.

The waste cassette rotator 836 further includes a plurality of ribs 851 which extend in a radially inward direction from the inner wall. The ribs 851 extend inwardly the length of the flange 852 with their base being in contact with the flange 852, and the ribs are thus supported across their base by the flange 852. The ribs 851 are formed on the wall 850 in pairs, as shown in FIG. 8a as 851a, 851b. The pairs of ribs are sized and shaped in an appropriate manner to engage with corresponding slots 971 on a waste storage cassette.

Each rib of the pair of ribs is separated by a distance at least as large as the width of a single rib. There are n pairs of ribs around the circumference of the inner wall 850, where n is preferably, though not necessarily, in a range 1≤n≤10. The rotator may also further comprise a fin 855. The fin 855 extends from an upper face of the flange 852 in an upward direction, substantially parallel to the cylindrical wall 850. The fin 855 is relatively thin in a radial dimension, and extends tangentially around the inner circumference of the flange 852. The fin does not contact the cylindrical wall, such that a peripheral gap between the fin 855 and the cylindrical wall is formed. The pairs of ribs 851a-n and the fin 855 are spaced substantially equidistantly around an inner circumference of the cylindrical wall 850. Alternatively, the pairs of ribs 851 a-n and the fin 855 may be at varying coplanar separations, or equally angularly spaced but omitting one or more pair of ribs. In a preferred embodiment, there are ten ribs, which together form five pairs of ribs, and one fin, all of which are spaced equidistantly around the flange 852.

In another embodiment, the fin is not provided, and instead the pattern of repeating raised projections around the flange of the rotator is skipped for one or more projections.

The rotator may also include a plurality of raised projections 853 interspaced between the pairs of ribs 851a-n and the fin 855. The raised projections 853 may be equally interspaced around the circumference of the cylindrical wall 850. The raised projections 853 extend in an upward direction from the flange 852 and in contact with the cylindrical wall 850, and extend at least part of the distance between the flange 850 and the upper annulus 854. The raised projections have a radial dimension substantially equal to that of the flange 852, and extend in a tangential direction around the flange 852.

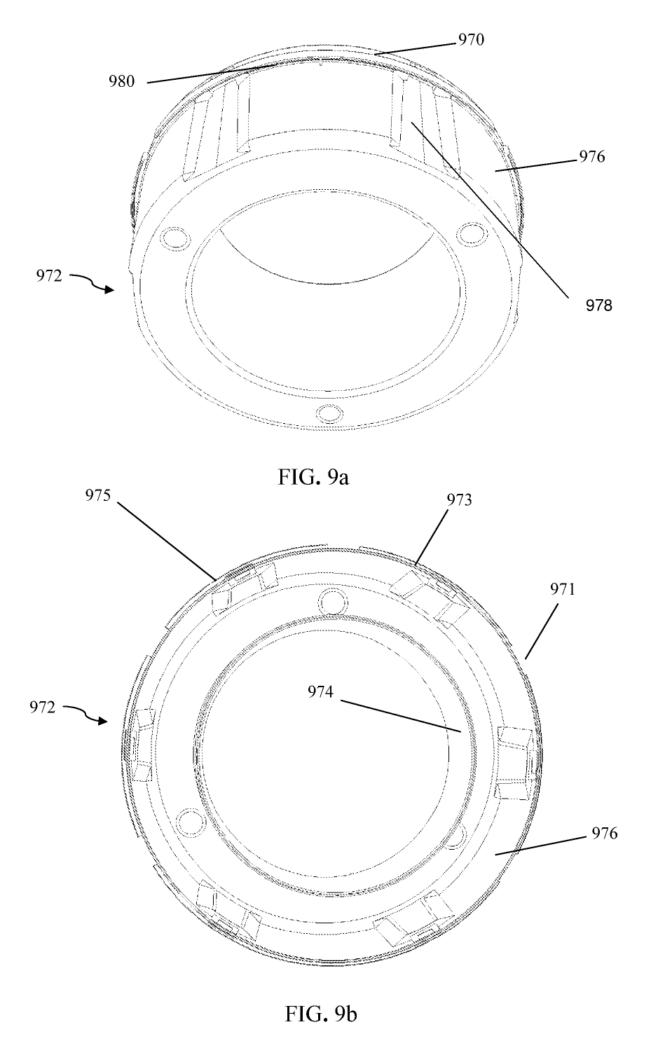

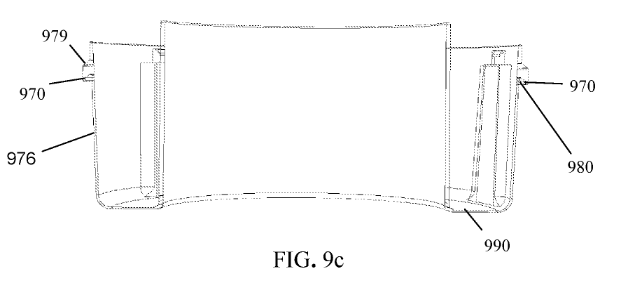

A corresponding alternative cassette embodiment is shown in FIGS. 9a-c. The alternative cassette embodiment 972 is similar in both structure and operation to the waste storage cassette described above.

The cassette outer wall 976 comprises a plurality of depressions or recesses 978, which extend in an axial direction for substantially the full height of the cassette 972. The diameter of the waste storage cassette 972 is decreased in the region of the recesses 978. The recesses 978 extend radially inward from an outer surface of the cassette outer wall 976 and may extend from the top to the bottom of the cassette, hence defining elongate depressions and/or regions where the cassette has a reduced diameter. The recesses 978 are spaced around the outer circumference of the cassette 972.

The waste storage cassette 972 includes a formation 973. The formation takes the form of an annular ledge or flange, which projects radially outwards from an outer surface of the cassette outer wall 976. As best seen in FIG. 9c, in some embodiments, the formation comprises a sloped annular flange 979. The sloped angular flange 979 extends outwards in a radial direction from the cassette outer wall 976, and is downwardly and outwardly sloped with respect to the waste storage cassette outer wall 976. A downwardly depending cylindrical outer wall 970 extends in a downward direction from an outermost portion of the sloped annular flange 979. The depending cylindrical outer wall 970 depends in a direction substantially parallel to the cassette outer wall 976, but at an increased radial distance from a central axis of the cassette 972. A gap between the downwardly depending cylindrical outer wall 970 and the cassette outer wall 976 defines an annular channel 980.

The formation 973 comprises a number of protrusions 975. The protrusions 975 extend radially outward from an outer surface of the cassette outer wall 976, and are separated by a corresponding number of gaps or slots 971. The slots 971 are sized, positioned and shaped appropriately in order to engage with the pairs of ribs 851a-n of the rotator 836. The slots 971 are spaced around the outer circumference of the formation 973. One of the protrusions is approximately twice as long as the other protrusions, and it is this protrusion which interacts and engages with the fin 855 of the rotator 836, as will be described below, rather than a rib or pair of ribs 851. In the preferred embodiment shown in FIGS. 9a and 9b, there are five slots 971.

When the cassette 972 is engaged with the rotator 836, each respective pair of ribs 851a-n engage with, i.e. fit inside, a corresponding slot 971 on the waste storage cassette 972. The fin 855 engages with, i.e. fits inside, the channel 980 of the cassette. The fin 855 thereby ensures that the cassette can only engage with the rotator 836 in a particular rotational orientation.

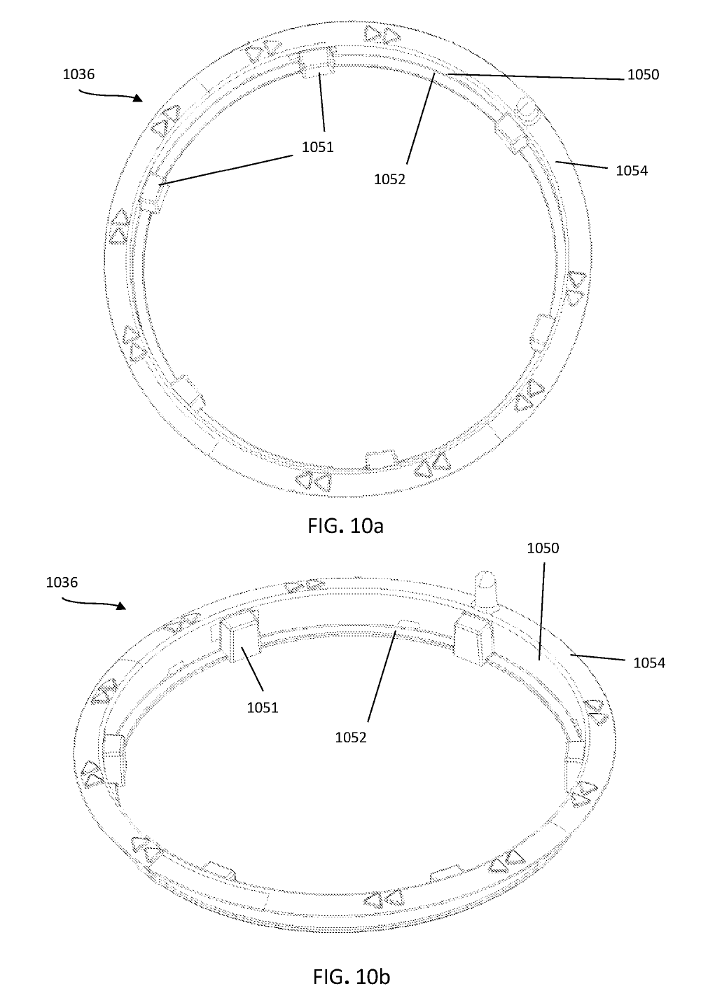

Another alternative rotator embodiment is shown in FIGS. 10a and 10b. According to this alternative embodiment, the rotator 1036 is similar in structure and operation to the rotators described above, and a person skilled in the art will appreciate that various combinations of the features of each rotator/rotate-ring disclosed herein are possible.

The waste cassette rotator 1036 comprises a cylindrical wall 1050 extending substantially concentrically with the walls of the cassette receiving chamber, and an upper annulus 1054 which extends radially outwards from the top of the wall 1050 so that it may rest on an upper surface of the cover. In some embodiments, a flange or annular base 1052 may extend radially inwards from a bottom region of the cylindrical wall 1050 and in a direction substantially perpendicular to the wall 1050.

The waste cassette rotator 1036 further includes a plurality of ribs 1051 which extend in a radially inward direction from the inner wall 1050, and extend substantially the whole height of the cylindrical wall 1050. The ribs 1051 may extend inwardly the length of the flange 1052, with the base of the ribs being in contact with the flange 1052 The ribs may thus be supported across their base by the flange 1052. Alternatively, in embodiments without the flange 1052, the ribs 1051 may simply extend from the cylindrical wall 1050. The ribs 1051 are sized, positioned and shaped in an appropriate manner to engage with corresponding recesses 1171 on a waste storage cassette.

There are n ribs around the circumference of the inner wall 1050, where n is preferably, though not necessarily, in a range 1≤n≤10, and may be, for example, 2≤n≤8. The ribs 1051 may be spaced substantially equidistantly around an inner circumference of the cylindrical wall 1050. Alternatively, the ribs 1051a-n may be positioned at varying angular separations, or may be equally angularly spaced but omitting one or more ribs. In a preferred embodiment, there are six ribs 1051 spaced equidistantly around the outer wall 1050.

The rotator may also further comprise a fin and/or a plurality of raised projections, as described above in relation to other embodiments, for example fin 855 as can be seen in FIGS. 8a and 8b and raised projections 153 as can be seen in FIGS. 5a and 5b

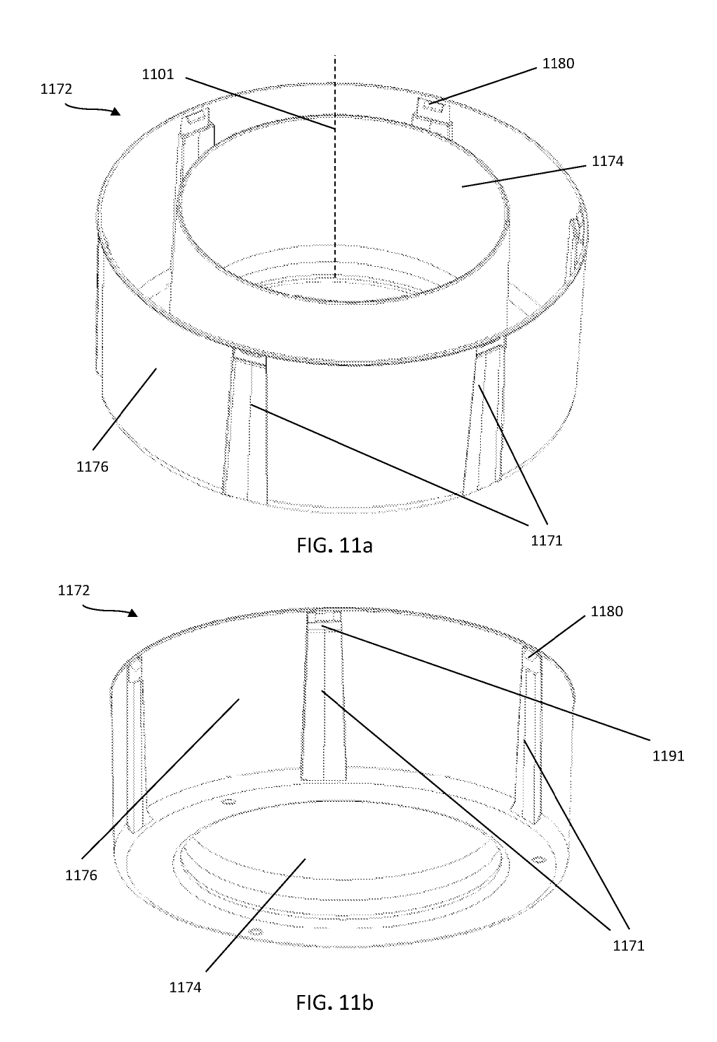

A corresponding further alternative cassette embodiment 1172 is shown in FIGS. 11a and 11b. Subject to the differences set out below, the further alternative cassette embodiment 1172 is similar in both structure and operation to the waste storage cassettes described above, and a person skilled in the art will appreciate that various combinations of the features of each waste storage cassette disclosed herein are possible.

Unlike the cassettes disclosed above, the cassette 1172 of this embodiment does not comprise an outwardly extending annular flange/formation (such as formation 173 as can be seen in FIG. 6a), or any outwardly extending radial projections (for example projections 175 as can be seen in FIGS. 6a and 6b). The outer wall 1176 of the cassette 1172 comprises at least one recess 1171, and in a preferred embodiment comprises a plurality of recesses 1171. The recesses 1171 extend radially inward from an outer surface of the cassette outer wall 1176 and extend from the top to the bottom of the cassette, hence defining elongate depressions and/or regions where the cassette has a reduced diameter. The recesses 1171 are spaced around the outer circumference of the cassette 1172, and are sized, positioned and shaped appropriately in order to engage with the pairs of ribs 1051 of the rotator 1036. In some embodiments, the recesses may be slots or apertures, which are again sized, positioned and shaped appropriately in order to engage with the pairs of ribs 1051.

In some embodiments, the cassette 1172 is cylindrical. It is possible to define a cylindrical axis which runs through the base of the cassette, as shown by dotted line 1101 in FIG. 11a. Each recess 1171 begins at the bottom of the cylindrical wall 1176 and extends upwards along the wall for substantially the full length of the cassette, in a direction parallel to the cylindrical axis.

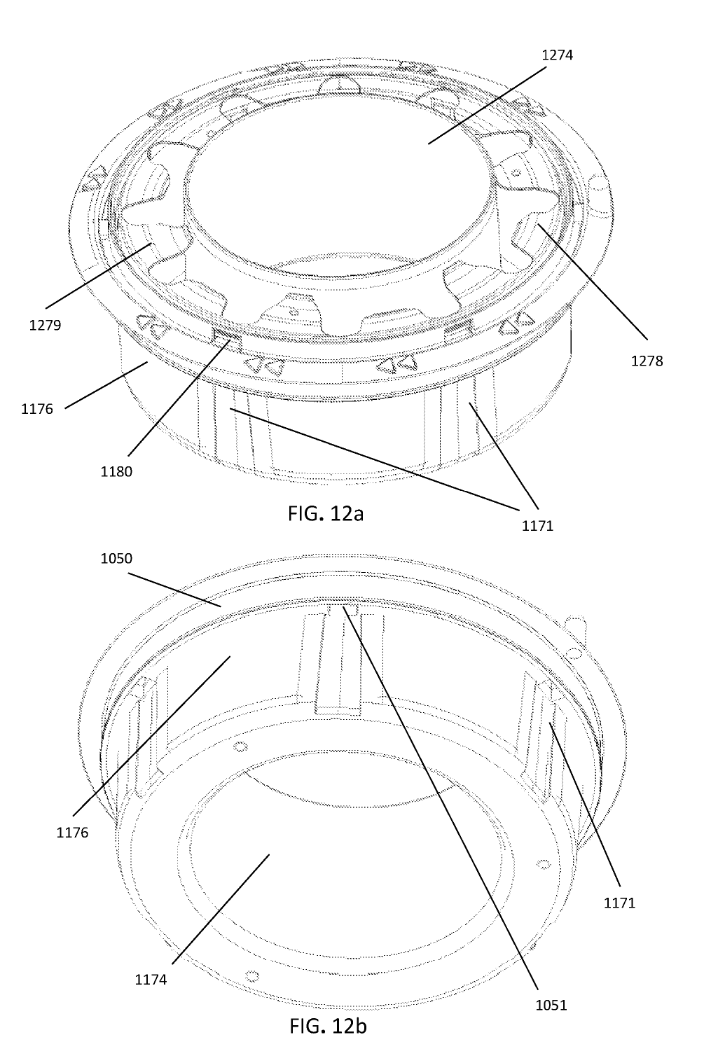

FIGS. 12a-b show the waste storage cassette of FIGS. 11a-b, with an annular flange 1279 attached thereto, coupled with/supported by the rotate ring 1036 of FIGS. 10a and 10b. As described above in relation to the annular flange 178 of FIGS. 6c and 7, the annular flange 1278 may comprise several inward projections or petals 1279 which extend radially inward from an outer rim of the annular flange 1278. When the flange 1278 is attached to the cassette 1172, the petals 1279 extend towards the inner wall 1174 of the cassette 1172, with a plurality of gaps 1177 therebetween which allow flexible tubing to be dispensed from the cassette housing below. Preferably, the outer edge of the flange 1278 is rounded so as to prevent snagging of the tubing when it passes thereover.

The flange 1278 can be clipped, snap-fitted or engaged to the cassette outer wall 1176 using any suitable means. In a preferred embodiment, protrusions 180 extend from the top rim of the cassette outer wall 1176. The outer wall 1176 of the cassette 1172 thus includes one or more inwardly extending protrusions 1180 on its inner surface, with which the outer rim of the annular flange 1278 interengages. During assembly, the flange 1278 can be engaged with the cassette 1172 by simply clipping the flange 1278 into position underneath the inwardly extending protrusions 1180. In this manner, the inwardly extending protrusions 1180 act together as a detent mechanism. Each extending protrusion 1180 of the plurality of extending protrusions 1180 extends radially inwards from an upper region of the cassette outer wall 1176 in the vicinity of a recess 1171. As can best be seen in FIG. 11b, each recess 1171 is associated with a corresponding extending protrusion 1180. The cassette also comprises a plurality of apertures 1191 in the cassette outer wall 1176 proximate the extending protrusions 1180. Each respective recess 1171 is vertically aligned with a protrusion 1180 and an aperture 1191 on the cassette outer wall 1176.

When the cassette 1172 is engaged with the rotator 1036, each respective rib 1051 of the rotator 1036 engages with, i.e. fits inside, a corresponding recess 1171 on the waste storage cassette 1172. As a user engages the cassette 1172 with the rotator 1036, the ribs 1051 act as guides within the recesses 1171 to ensure proper engagement of the cassette 1172 and the rotator 1036.

FIGS. 12a and 12b show the annular flange 1278 engaged with the cassette 1172, and the cassette 1172 being supported by the rotator 1036. FIGS. 12a and 12b thus show the cassette in a supported position. To fit the cassette 1172 into the rotator 1036, a user aligns the recesses 1171 in the cassette outer wall 1176 with the ribs/projections 1051 in the rotator/rotate ring 1036 and pushes the cassette 1172 down into the waste storage chamber. Each rib 1051 fits into a corresponding recess 1171 in the cassette outer wall 1176. As a user pushes the cassette down into the waste storage chamber, the ribs 1051 guide the vertical movement of the cassette and thus ensure proper engagement of the cassette 1172 and rotator 1036. Because of the arrangement of the extending protrusions 1180, apertures 1191, annular flange 1278 and ribs 1051, as a user continues to push the cassette downwards inside the chamber, a top region of the ribs 1051 comes into contact with an underside of the outer rim of the annular flange 1278. The underside of the outer rim of the annular flange 1278 thus acts as a stop. In this way, the projections/ribs 1051 provided on the inner surface of the rotator cylindrical wall 1050 are arranged to locate with the recesses 1171 on the waste storage cassette 1172 in order to support the waste storage cassette 1172 in the chamber, and to ensure rotational engagement between the rotator 1036 and the cassette 1172.

In some embodiments, as a user pushes the cassette 1172 down inside the waste storage cassette chamber, a top region of the ribs 1051 comes into contact with the inwardly extending protrusions 1180. In some embodiments, the cassette 1172 may comprise an outer lip or flange in the vicinity of the recesses which contacts the ribs as the cassette is pushed down inside the chamber in order that the cassette can be supported by the ribs in the chamber. This outer lip or flange may be continuous or discontinuous around the circumference of the cassette. Alternatively, there may be several lips or flanges provided on the outer wall of the cassette 1172 which are sized, positioned and shaped in an appropriate manner to contact or otherwise engage with corresponding ribs on a rotator. Alternatively, the recesses 1171 may not extend along the full outer wall of the cassette, but may instead extend from the bottom of the cassette and come to an end at a predetermined distance up the cassette wall. In such an embodiment, the end point of the recesses 1171 acts as a stop, and thus defines the end-point of the movement as a user pushes the cassette 1172 down inside the waste storage cassette chamber.

In some embodiments, the cassette is not supported in the rotator by a top region of the ribs of the rotator. Instead, the recesses in the cassette outer wall are sized and shaped such that the cassette is supported by a friction fit between the ribs and recesses. In such an embodiment, the recesses may be shaped such that they become narrower toward the top of the cassette, to allow the ribs to fit into the recesses only up to a certain pre-determined point in a wedging action.

Supporting the cassette in the waste storage chamber via an interaction between ribs which extend from a cylindrical wall of a rotator and recesses formed in a cassette outer wall is advantageous for several reasons. Further to the advantages described above in relation to the other disclosed embodiments, for example the increased rotational engagement and reduced slippage between the rotator and the waste storage cassette, the arrangement shown in FIGS. 8-12 has the advantage that the rotator is no longer required to have an inwardly extending annular flange, and the cassette is no longer required to have an outwardly extending annular flange. Because these features of the cassette and rotator are no longer required, material wastage may be reduced, and a more cost-effective manufacturing process and product is provided. Also, because the cassette no longer requires an extending annular flange or any radially extending protrusions, the cassette can be made larger for a given size of waste storage chamber and rotator. This means an increased amount of tubing can be stored in the cassette, which decreases the amount of time required before the cassette must be replaced by a user, and provides further cost-efficiencies for the manufacturer, for example when transporting and storing the waste storage cassettes.

Whilst the ribs in the embodiments described above are placed on the rotator, and the corresponding slots/recesses are provided in an outer flange or formation of the cassette, it will be appreciated that these features could be interchanged, i.e. the ribs could be provided on an outer surface of the cassette, and corresponding slots/recesses could be provided on the rotator.

Whilst FIGS. 1 to 7 show a rotator and cassette having six ribs and six slots respectively, and FIGS. 8 to 9 show a rotator and cassette having five ribs and five slots respectively, it will be appreciated that any number of ribs and slots can be provided. It will further be appreciated that the number of ribs may not necessarily be equal to the number of slots. In some embodiments, for example, many more slots than ribs may be provided, in order to maximize the available number of possible rotational configurations with which the cassette can engage with the rotator. A rotator and cassette according to this embodiment allow a user to more quickly and simply orientate the cassette in the rotator. It will be appreciated that it is possible to have almost any number of ribs, slots and fins.

It will further be appreciated that the ribs and slots may not necessarily take the exact form described herein. For example, whilst the ribs have been described as extending the full distance between the upper annular surface of the rotator down to the flange or annular base of the rotator, the ribs may not necessarily extend this full distance. For example, the ribs may extend from the annular base to a point halfway up the cylindrical wall of the rotator. It is also not necessary for the ribs to contact either the annular base or the upper annular surface, but may instead take the form of projecting fingers which extend radially inward from any point between the annular base and upper annular surface. The slots in the cassette can be adjusted accordingly to interact with these ribs.

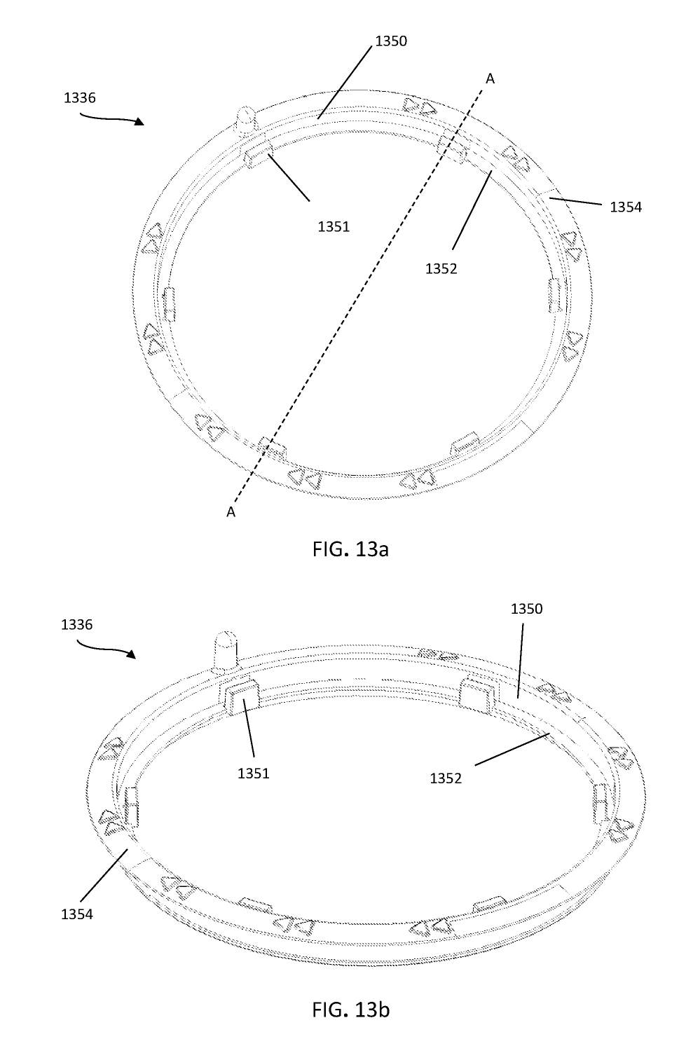

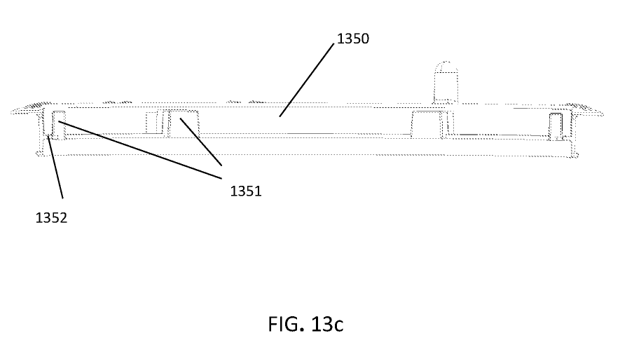

Another alternative rotator embodiment is shown in FIGS. 13a, 13b and 13c. FIG. 13c shows a cross-section view of the rotator 1336 along the line A-A shown in FIG. 13a. According to this alternative embodiment, the rotator 1336 is similar in structure and operation to the rotators described above, and a person skilled in the art will appreciate that various combinations of the features of each rotator/rotate-ring disclosed herein are possible. The rotator 1336 is compatible with the waste storage devices and cassettes disclosed herein, as would be understood by the skilled person.

As with the rotators described above, the waste cassette rotator 1336 comprises a cylindrical wall 1350 extending substantially concentrically with the walls of the cassette receiving chamber, and an upper annulus 1354 which extends radially outwards from the top of the wall 1350 so that it may rest on an upper surface of the cover. A flange or annular base 1352 extends radially inwards from a bottom region of the cylindrical wall 1350 and in a direction substantially perpendicular to the wall 1350.

In this embodiment, the waste cassette rotator 1336 includes a plurality of projections 1351, however the projections 1351 do not extend from the cylindrical wall 1350, but instead extend in an axial, upward direction from the flange 1352. The projections 1351 may extend substantially the whole height of the cylindrical wall 1350.

As can best be seen in FIG. 13c, the projections 1351 extend upward from the rotator flange 1352 at a position radially inward from the rotator cylindrical wall 1350, and are radially separated from the cylindrical wall 1350. As shown in FIG. 13c, the projections 1351 extend upwardly from the rotator flange 1352 at or near the radially innermost edge of the rotator flange 1352. The projections 1352 may also jut out from the radially innermost edge of the flange 1352.

The rotator 1336 is compatible with the previously disclosed waste storage cassettes. For example, when a user wishes to engage rotator 1336 with a cassette such as the cassette shown in FIGS. 9a-c, the user maneuvers the cassette so that the projections 1351 fit into the annular channel 980 of the cassette, the annular channel 980 being defined by the gap between the downwardly depending cylindrical outer wall 970 and the cassette outer wall 976. As the projections 1351 fit into the annular channel 980, the depending cylindrical outer wall 970 also rests on, and is thus supported by, the rotator flange 1352. The cassette is thus suspended by its depending cylindrical outer wall 970 from the rotator flange 1352. In some embodiments, the cassette may be designed to have recesses 978/1171 which are sized, positioned and shaped to locate with the projections 1351. In these embodiments, the projections 1351 fit into both the annular channel 980 and the recesses 978/1171.

When a user wishes to engage rotator 1336 with a cassette such as the cassette shown in FIGS. 11a-b, the user maneuvers the cassette so that the projections 1351 fit into the corresponding recesses 1171, in a similar manner to the engagement described above between cassette 1172 and rotator 1036. When the cassette 1172 is engaged with the rotator 1336, each respective projection 1351 of the rotator 1336 engages with, i.e. fits inside, a corresponding recess 1171 on the waste storage cassette 1172. As a user engages the cassette 1172 with the rotator 1336, the projections 1351 act as guides within the recesses 1171 to ensure proper engagement of the cassette 1172 and the rotator 1036.

Providing projections 1351 on a rotator 1336 which fit into an annular channel 980 on a cassette 972 allows for strong engagement between the rotator and the cassette. The projections 1351 are radially separated from the rotator cylindrical wall 1350, and thus a space is provided for the depending cylindrical outer wall 970 of the cassette 972 to rest on the rotator flange 1352. The increased contact surface area between the cassette 972 and rotator 1336 provided by this arrangement increases rotational engagement and reduces slippage between the rotator 1336 and the waste storage cassette 972. Providing projections 1351 which extend upwardly from a rotator flange 1352 at or near the radially inner edge of the rotator flange 1352, rather than which extend from the rotator cylindrical wall 1350, also reduces the material required to fabricate the rotator 1336 which in turn saves manufacturing costs.

It will be appreciated by the skilled person that the terms ribs and projections have been used interchangeably herein.

The following items are herein disclosed:
1. A waste storage device including a receiving chamber provided in an upper part of the device and a rotator rotatably mounted in the chamber; the rotator comprising:
   an upper annulus;
   a cylindrical wall extending downwardly from the upper annulus;
   a flange projecting inwardly from a lower portion of the cylindrical wall, wherein the rotator is arranged for suspending a waste storage cassette from the inwardly projecting flange for rotation thereof; and
   at least one rib or at least one slot provided on an inner surface of the rotator cylindrical wall, said at least one rib or at least one slot being arranged to locate with at least one corresponding slot or at least one corresponding rib on a waste storage cassette for rotational engagement therewith.
2. A waste storage device of item 1, wherein the at least one rib comprises a plurality of ribs, and the at least one slot comprises a plurality of slots.
3. A waste storage device of item 2, wherein each rib of the plurality of ribs is arranged to locate with a respective slot on the waste storage cassette.
4. A waste storage device of item 2 or item 3, wherein the ribs are spaced equidistantly apart around the cylindrical wall to define an equidistant arrangement.
5. A waste storage device of item 4, wherein one or more rib is omitted from the equidistant arrangement.
6. A waste storage device of item 2, wherein at least two of the plurality of ribs on the rotator are arranged to locate with a common slot on the waste storage cassette.
7. A waste storage device of item 6, wherein the at least two of the plurality of ribs comprise one pair of a plurality of pairs of ribs, each pair of the plurality of pairs of ribs being spaced around the inner surface of the rotator cylindrical wall, and each pair of the plurality of pairs of ribs being arranged to locate with a corresponding plurality of slots.
8. A waste storage device of any preceding item wherein the at least one rib is provided on an inner surface of the cylindrical wall.
9. A waste storage device of any preceding item, wherein the ribs are arranged to extend between the upper annulus and the flange.
10. A waste storage device of any preceding item, further comprising a waste storage cassette suspended from said rotator.
11. A waste storage device of item 10, wherein the cassette is of any of items 12 to 22.
12. A waste storage cassette for rotational mounting and suspension in a chamber provided in an upper part of a waste storage device, the waste storage cassette comprising:
   an inner wall defining a substantially tubular core;
   an outer wall;
   a storage section provided between the inner wall and the outer wall for containing waste storage tubing for creating waste packages;
   at least one slot or at least one rib on an outer surface of the cassette, the at least one slot or at least one rib being arranged to locate with at least one rib or at least one slot provided on an inner surface of a waste storage cassette rotator for rotational engagement.
13. A waste storage cassette of item 12, wherein the at least one rib comprises a plurality of ribs, and the at least one slot comprises a plurality of slots.
14. A waste storage cassette of item 13, wherein each slot of the plurality of slots is arranged to locate with a respective rib on a rotator of a waste storage device.
15. A waste storage cassette of item 13 or item 14, wherein a slot on the waste storage cassette is arranged to locate with a plurality of ribs on the rotator.
16. A waste storage cassette of item 15, wherein a slot on the waste storage cassette is arranged to locate with one pair of a plurality of pairs of ribs on the rotator.
17. A waste storage cassette of any of items 13 to 16, wherein the slots are spaced in an equidistant arrangement equidistantly apart around the outer surface of the waste storage cassette.
18. A waste storage cassette of any of item 17, wherein at least one slot is omitted from the equidistant arrangement.
19. A waste storage cassette of any of items 13 to 18, wherein the slots comprise interruptions in a formation that projects radially from the outer wall of the cassette, wherein said formation is configured to locate a rotator provided in the chamber of a waste storage device, for support and rotation of the cassette.
20. A waste storage cassette of item 19 wherein said formation enables the waste storage cassette to be suspended from the rotator.
21. A waste storage cassette of any of items 19 to 20, wherein the formation comprises a plurality of protrusions, separated by respective slots, forming an outer flange.
22. A waste storage cassette for rotational mounting and suspension in a chamber provided in an upper part of a waste storage device, the waste storage cassette comprising:
   an inner wall defining a substantially tubular core;
   an outer wall;
   an annular bottom section which joins the inner and outer walls;
   a storage section provided between the inner wall and the outer wall for containing waste storage tubing for creating waste packages;
   a formation provided on said outer wall, the formation extending in a circumferential direction from the outer wall and comprising a plurality of slots or a plurality of ribs spaced apart around the outer circumference of the formation, each slot or each rib being arranged to locate with a respective rib or a respective slot provided on an inner surface of a waste storage cassette rotator for rotation of the cassette with respect to the waste storage chamber.
23. A waste storage cassette rotator for use in a waste storage device, the waste storage device including a receiving chamber provided in an upper part of the device, the waste storage cassette rotator arranged to be rotatably mounted in the chamber and comprising:
   an upper annulus;
   a cylindrical wall extending downwardly from the upper annulus;
   a flange projecting inwardly from a lower portion of the cylindrical wall, wherein the waste storage cassette rotator is arranged for suspending the waste storage cassette from the inwardly projecting flange for rotation thereof; and
   at least one rib or at least one slot provided on an inner surface of the waste storage cassette rotator, the at least one rib or at least one slot being arranged to locate with at least one corresponding slot or at least one corresponding rib on a waste storage cassette for rotational engagement therewith.
24. A waste storage device including: a rotator of item 23, a waste storage cassette receiving chamber provided in an upper part of the device, and a waste storage cassette, the waste storage cassette comprising:
   an inner wall defining a substantially tubular core;
   an outer wall;
   a storage section provided between the inner wall and the outer wall for containing waste storage tubing for creating waste packages;
   a formation provided on said outer wall, projecting from the outer wall and configured to locate the waste storage cassette rotator provided in the chamber for support and rotation of the cassette, wherein said formation enables the waste storage cassette to be suspended from the waste storage cassette rotator; and
   at least one slot or at least one rib provided on an outer surface of the outer wall, the at least one slot or at least one rib being arranged to locate with the at least one rib or at least one slot provided on the inner surface of the rotator.
25. A waste storage device comprising a receiving chamber provided in an upper part of the device and a rotator rotatably mounted in the chamber; the rotator comprising:
   an upper annulus;
   a cylindrical wall extending downwardly from the upper annulus;
   at least one rib provided on an inner surface of the rotator cylindrical wall, said at least one rib being arranged to locate with at least one corresponding recess on a waste storage cassette to support the waste storage cassette in the chamber and to ensure rotational engagement between the rotator and the cassette.

1. A waste storage device comprising a receiving chamber provided in an upper part of the device and a rotator rotatably mounted in the chamber; the rotator comprising:
an upper annulus;
a cylindrical wall extending downwardly from the upper annulus;
wherein the rotator comprises at least one projection extending therefrom, said at least one projection being arranged to locate with at least one corresponding recess on a waste storage cassette to support the waste storage cassette in the chamber and to ensure rotational engagement between the rotator and the cassette.

2.-35. (canceled)
